(19) United States
(12) Patent Application Publication
(10) Pub. No.: US 2013/0009085 A1
(43) Pub. Date: Jan. 10, 2013

(54) Ball Valve With Anti-Backflow Device

(75) Inventor: Kenneth J. Kuzelka, Island Lake, IL (US)

(73) Assignee: Michael D. Stolzman

(21) Appl. No.: 13/176,943

(22) Filed: Jul. 6, 2011

(51) Int. Cl. F16K 5/06

(52) U.S. Cl. 251/315.06

(57) ABSTRACT

A bulk container anti-backflow ball valve is adapted for use with a bulk container having a tubular spout. The valve comprises a housing having an interior spherical chamber connecting an inlet port to an outlet port. The housing includes an inlet fitting about the inlet port for connection to the spout, in use. A valve element is rotationally supported in the interior chamber of the housing for movement between a valve open position and a valve closed position. The valve element comprises a spherical ball having a through bore defining a cylindrical interior passage. A wall extends across the interior passage separating an inlet side of the passage from an outlet side of the passage. The wall includes a through opening. An anti-backflow device is received in the outlet side of the passage aligned with the through opening and is movable between a seated position and a spaced position relative to the wall. Flow from the inlet side to the outlet side moves the anti-backflow device to the spaced position to open the through opening. Flow from the outlet side to the inlet side moves the anti-backflow device to the seated position to close the through opening. A handle is provided for selective rotation of the valve element in the housing.

### FIELD OF THE INVENTION

This invention relates to intermediate bulk storage containers and, more particularly, to a bulk container valve having an integral anti-backflow device.

### BACKGROUND OF THE INVENTION

For shipment of goods, a storage system known as an intermediate bulk container (IBC) has found wide acceptance. An IBC, in one typical form, comprises a 275 gallon container mounted to a skid or pallet. A wire mesh cage is also mounted to the skid and surrounds the container on all four sides. The top of the container is generally exposed. Additional pallets or IBC's may then be stacked for shipping and storage.

The IBC is filled at its top by removing a cover providing access to an opening. A bottom spout acts as an outlet for goods stored in the container. A bulk container valve is typically removably secured to the IBC to control removal of goods from the container. Typically the valve is threaded onto the spout. A hose can then be connected to the valve to empty the contents of the IBC.

A typical IBC valve comprises a plastic housing with a valve element contained within the housing. A handle attaches to the valve element. The typical IBC valve can be rotated to a closed position therein no flow out of the IBC is permitted. The valve can be opened to a fully opened or intermediate position to selectively control rate of flow out of the IBC. Such a structure allows for backflow into the IBC through the IBC valve. Various regulations and the like compel users to take steps to prevent backflow into the IBC. One manner in which this is accomplished is by adding a secondary device that must first be attached to the IBC valve to allow for the required one-way valve function. This results in additional components to be maintained as well as additional costs.

The present invention is directed to solving one or more of the problems discussed above in a novel and simple manner.

### SUMMARY OF THE INVENTION

In accordance with the invention, there is provided a bulk container valve including an integral anti-backflow device inside the valve.

Broadly, there is disclosed in accordance with one aspect of the invention a bulk container anti-backflow valve adapted for use with a bulk container having a discharge outlet. The valve comprises a housing having an interior chamber connecting an inlet port to an outlet port. The housing includes an inlet fitting about the inlet port for connection to the discharge outlet, in use. A valve element is rotationally supported in the interior chamber of the housing for movement between a valve open position and a valve closed position. The valve element comprises a body having a through bore defining an interior passage. A wall extends across the interior passage separating an inlet side of the passage from an outlet side of the passage. The wall includes a through opening. An anti-backflow device is slidably received in the outlet side of the passage aligned with the through opening. Flow from the inlet side to the outlet side displaces the anti-backflow device from the wall to open the through opening. Flow from the outlet side to the inlet side causes the anti-backflow device to close the through opening. A handle is provided for selective rotation of the valve element in the housing.

It is a feature of the invention that the anti-backflow device comprises a plate having a plurality of stabilizing pins extending rearwardly from the plate. The wall comprises a plurality of pin openings. The stabilizing pins are received in the pin openings.

It is another feature of the invention to comprise backing screws on the inlet side of the passage threaded to the stabilizing pins to retain the stabilizing pins in the pin openings.

It is a further feature of the invention that area of the through opening is substantially equal to planar area across the passage surrounding the anti-backflow device.

It is another feature of the invention to provide a gasket between the anti backflow device and the wall.

It is still another feature of the invention that the anti-backflow device is maintained within the passage.

It is still another feature of the invention that the body comprises a spherical ball.

There is disclosed in accordance with another aspect of the invention a bulk container anti-backflow ball valve adapted for use with a bulk container having a discharge outlet. The valve comprises a housing having an interior spherical chamber connecting an inlet port to an outlet port. The housing includes an inlet fitting about the inlet port for connection to the discharge outlet, in use. A valve element is rotationally supported in the interior chamber of the housing for movement between a valve open position and a valve closed position. The valve element comprises a spherical ball having a through bore defining a cylindrical interior passage. A wall extends across the interior passage separating an inlet side of the passage from an outlet side of the passage. The wall includes a through opening. An anti-backflow device is received in the outlet side of the passage aligned with the through opening and is movable between a seated position and a spaced position relative to the wall. Flow from the inlet side to the outlet side moves the anti-backflow device to the spaced position to open the through opening. Flow from the outlet side to the inlet side moves the anti-backflow device to the seated position to close the through opening. A handle is provided for selective rotation of the valve element in the housing.

Further features and advantages of the invention will be readily apparent from the specification and from the drawing.

### BRIEF DESCRIPTION OF THE DRAWING

FIG. 1 is a perspective view of an intermediate bulk container (IBC) including a valve according to the invention;

FIG. 2 is a perspective view of the valve according to the invention;

FIG. 3 is a perspective view of the valve of FIG. 2 with a section removed;

FIG. 4 is a front elevation view of the valve of FIG. 2;

FIG. 5 is a front elevation view of the valve of FIG. 2 with a backflow device removed;

FIG. 6 is a perspective view of the valve element according to the invention; and

FIG. 7 is an exploded perspective view of the valve element according to the invention.

### DETAILED DESCRIPTION OF THE INVENTION

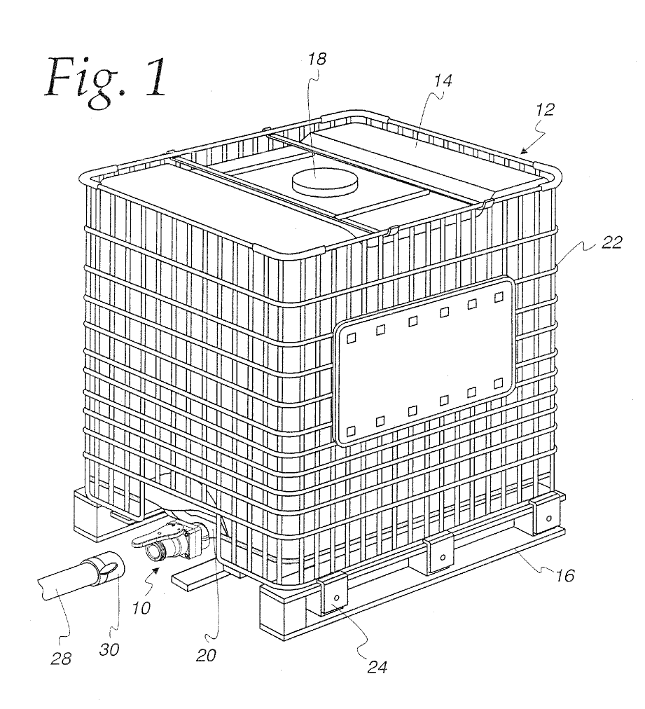

Referring to FIG. 1, a bulk container valve 10 according to the invention is illustrated mounted to a portable tank such as an intermediate bulk container (IBC) 12. The IBC 12 comprises a 275-gallon plastic container 14 resting on a pallet or skid 16. The container 14 can be filled at its top as by removing a cover 18 providing access to an opening (not shown). A discharge outlet, such as a bottom spout 20, acts as an outlet for goods stored in the container 14. The container 14 is surrounded on all four sides by a wire mesh cage 22. The cage 22 is secured to the pallet 16 using brackets 24.

The valve 10 could be used with other types of IBCs, portable tanks, or the like, as will be apparent to those skilled in the art. Such containers may provide capacity in the range of 120 to 793 gallons. Also, the IBC could be manufactured of metal or be of composite construction, as is known. As used herein, the term intermediate bulk container is intended to also refer more generally to portable tanks, as is known in the art.

The spout 20 is a tubular spout including an external thread (not shown). The valve 10 is adapted to be threadably connected to the spout 20. As is apparent, other attachment means could be provided. A hose 28 includes a cam lever coupling element 30 for securing the hose 28 to the valve 10 in a conventional manner. As described, the valve 10 is selectively operated to empty the contents from the container 14 to the hose 28 for ultimate disposition.

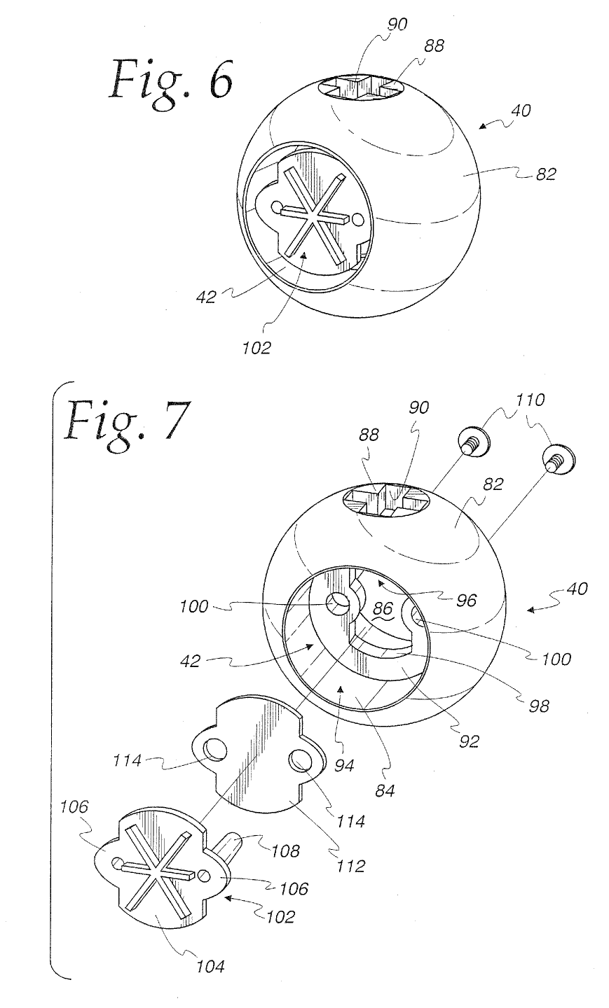

With reference to FIGS. 2-5, the valve 10 comprises a plastic housing 32 having an interior chamber 34 connecting an inlet port 36 to an outlet port 38. A generally spherical ball valve element 40, see also FIG. 6, is rotationally supported in the interior chamber 34 for movement between a valve open position and a valve closed position, as is known. In the valve open position, a cylindrical through bore 42 in the valve element 40 is aligned with the inlet port 36 and the outlet port 38. In the valve closed position, not shown, the through bore 42 is oriented in a plane perpendicular to a longitudinal axis of the valve 10 so that there is no fluid communication between the inlet port 36 and the outlet port 38. A handle 44 includes an internal stem 46. The stem 46 extends through a transverse housing opening 48 to be operatively mated with the valve element 40, as described below, for selective rotation of the valve element 40 between the open and closed positions.

The housing 32 comprises a two-piece plastic housing having a front housing part 48 and a rear housing part 50. For simplicity herein, the longitudinal end of the valve 10 furthest from the IBC 14, in use, is referred to as the front, while the opposite end closest to the IBC is referred to as the rear. As such, the rear portion comprises the inlet side and the front portion comprises the outlet side.

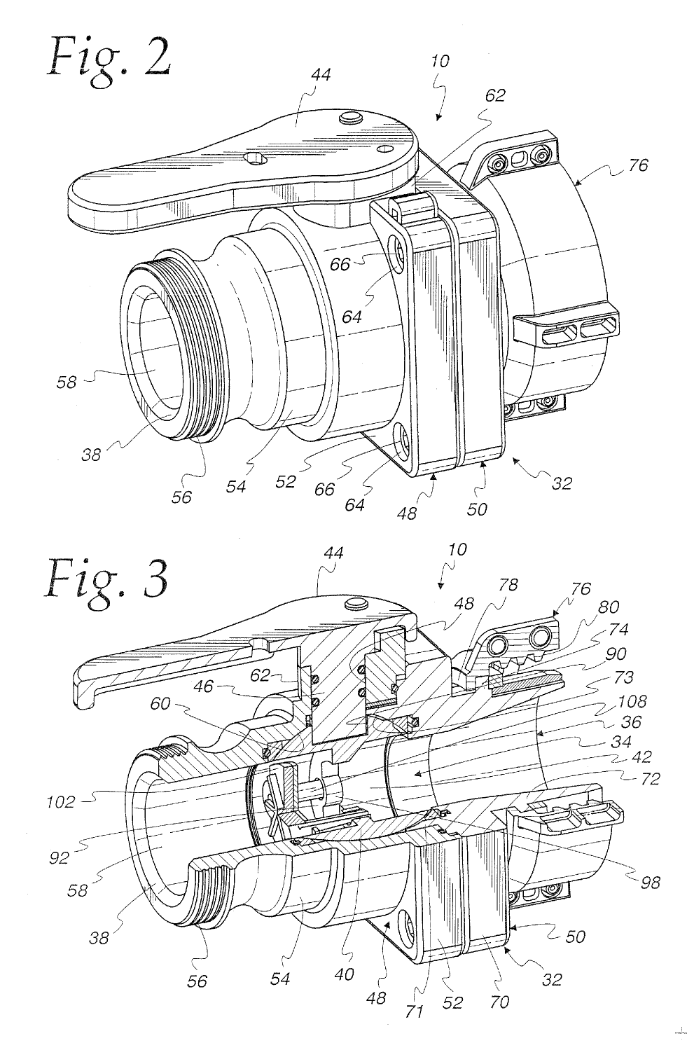

The front housing part 48 includes a front flange 52 connecting a cylindrical wall 54 to a front fitting 56. A through bore 58 extends through the front housing part 48 and connects the outlet port 38 to a generally spherical counterbore 60, see FIG. 3. The transverse housing opening 48 extends through a projection 62 extending upwardly from the front flange 52 and the wall 54. The transverse opening 48 opens into the counterbore 60, as illustrated.

The flange 52 is generally square-shaped with the cylindrical wall 54 generally centrally positioned thereon. Proximate each corner of the flange 52 is a through opening 64. A bolt 66 extends through each opening 64, seated on an internal counterbore, not shown, for securing the front housing part 48 to the rear housing part 50, as is known.

The rear housing part 50 includes a rear flange 70 of a size and shape corresponding to the front flange 52. The rear flange 70 is connected to a rearwardly extending tubular neck 72 adapted to be received in the spout 20 and defining the inlet port 36. The neck 72 includes an annular ridge 74 proximate the flange 70. A two piece plastic collar 76 is mounted to the tubular neck 72 and has an inwardly directed flange 78 sandwiched between the flanges 70 and 74. The collar 76 has an inner threaded surface 80 for threading to the spout 20, as is known. A cylindrical extension 71 extends frontwardly of the rear flange 70 and has a generally spherical counterbore 73. The interior chamber 34 is generally spherical and is formed be the generally spherical counterbores 60 and 73, as is apparent in FIG. 3.

The structure of the valve housing 32, as discussed above, is for illustration only. The particular design of the valve housing does not form part of the invention. Instead, the invention is directed to anti-backflow features of the valve element 40 for use as part of an overall valve structure. Also, the valve housing 32 has numerous seals as are shown in the drawings but are not discussed in detail herein.

Referring to FIGS. 6 and 7, the valve element 40 comprises a generally spherical ball 82 having the cylindrical through bore 42 formed by an inner cylindrical wall 84 to define a cylindrical interior passage 86. A flat 88 is provided on one side of the ball 82 in a plane parallel to a longitudinal axis of the through bore 42. A groove 90 in the shape of a “+” extends into the spherical ball 82 at the flat 88. When the valve element 40 is positioned in the housing 32, the flat 88 is aligned with the transverse through opening 48 and the stem 46 extends into the groove 90, as is generally shown in FIG. 3.

A wall 92 is connected across the inner cylindrical wall 84 to separate the passage 86 into an outlet side 94 and an inlet side 96. The wall 92 includes an enlarged central through opening 98. A pin opening 100 is provided on either side of the central through opening 98.

An anti-backflow device 102 is of one piece plastic construction. The device 102 comprises a plate 104 of a size and shape larger than the wall central through opening 98 and having wings 106 extending on either side. A stabilizing pin 108 extends rearwardly from each of the wings 106. The stabilizing pins 108 are of a size to be slidably received in the pin openings 100 with the plate 104 on the passage outlet side 94. Backing screws 110 are threaded into distal ends of the pins 108 to retain the stabilizing pins 108 in the pin openings 100. The anti-backflow device 102 is in the outlet side 94 of the passage 86 aligned with the central through opening 98 and movable between a seated position (not shown) and a spaced position relative to the wall 92.

A Viton gasket 112 has a shape corresponding to that of the plate 104 and a pair of openings 114 for receiving the alignment pins 108. As such, the gasket 112 is positioned on a rear side of the anti-backflow device 102.

Referring to FIG. 3, fluid flow from the inlet port 36 to the outlet port 38 forces the anti-backflow device 102 frontwardly, i.e., spaced away from the wall 92, to open the through opening 98. Flow from the outlet port 38 to the inlet port 36, comprising back flow, moves the anti-backflow device 102 rearwardly to the seated position against the wall 92 to close the through opening 98. As is apparent, the gasket 112 seals the opening.

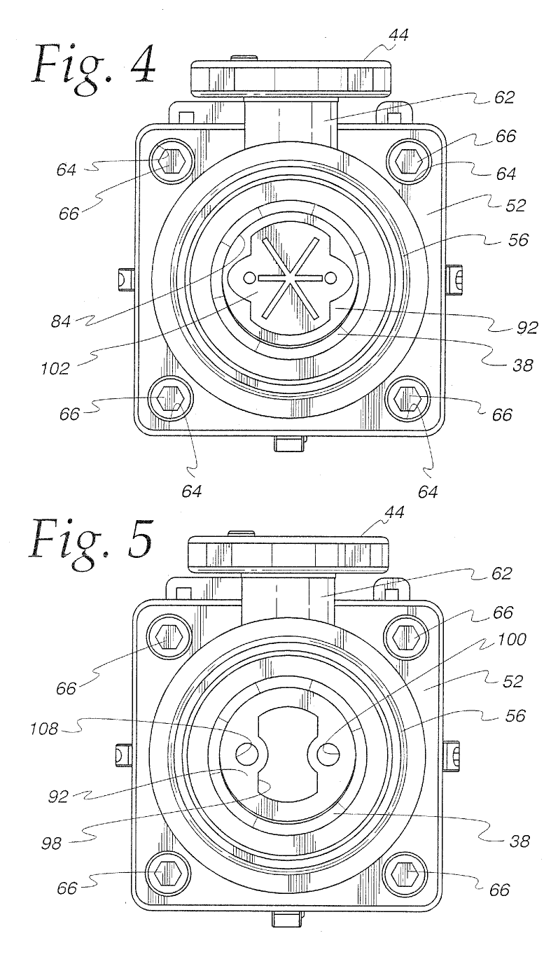

In accordance with the invention, the product flow area through the ball valve central through opening 98, shown in FIG. 5, and the area around the backflow device 102 within the cylindrical wall 84, shown in FIG. 4, are substantially equal. This relationship avoids any pressure drops associated with the inclusion of the anti-backflow device 102 inside the valve element 40.

As illustrated, all of the anti-backflow components fit within the spherical ball 82. This allows for complete operation of the valve 10 in any open or closed position. Likewise, the anti-backflow device 102 will work in any valve open or closed position.

With the valve 10 in the open position, the fluid within the IBC 14 will force the anti-backflow device 102 open due to forward fluid transfer. The anti-backflow device 102 remains in the open position unless sufficient backward force is exerted which would otherwise allow fluid to transfer in the opposite direction.

The described features and principles used in the design of the valve 10 provide for a flow rating of approximately 10 gallons per minute. Moreover, the valve is constructed of substantially all plastic construction with respect to components subject to process materials. This avoids corrosion and the like and provides a lighter weight design.

Thus, there is provided a ball valve with an integral anti-backflow device.

I claim:

1. A bulk container anti-backflow valve adapted for use with a bulk container having a discharge outlet, the valve comprising:
a housing having an interior chamber connecting an inlet port to an outlet port, the housing including an inlet fitting about the inlet port for connection to the discharge outlet, in use;
a valve element rotationally supported in the interior chamber of the housing for movement between a valve open position and a valve closed position, the valve element comprising a body having a through bore defining an interior passage, a wall extending across the interior passage separating an inlet side of the passage from an outlet side of the passage, the wall including a through opening, and an anti-backflow device slideably received in the outlet side of the passage aligned with the through opening, wherein flow from the inlet side to the outlet side displaces the anti-backflow device from the wall to open the through opening and flow from the outlet side to the inlet side causes the anti-backflow device to close the through opening; and
a handle for selective rotation of the valve element in the housing.

2. The bulk container anti-backflow valve of claim 1 wherein the anti-backflow device comprises a plate having a plurality of stabilizing pins extending rearwardly from the plate, the wall comprises a plurality of pin openings, and the stabilizing pins are received in the pin openings.

3. The bulk container anti-backflow valve of claim 2 further comprising backing screws on the inlet side of the passage threaded to the stabilizing pins to retain the stabilizing pins in the pin openings.

4. The bulk container anti-backflow valve of claim 1 wherein area of the through opening is substantially equal to planar area across the passage surrounding the anti-backflow device.

5. The bulk container anti-backflow valve of claim 1 further comprising a gasket between the anti-backflow device and the wall.

6. The bulk container anti-backflow valve of claim 1 wherein the anti-backflow device is maintained within the passage.

7. The bulk container anti-backflow valve of claim 1 wherein body comprises a spherical ball.

8. A bulk container anti-backflow ball valve adapted for use with a bulk container having a discharge outlet, the valve comprising:
a housing having an interior spherical chamber connecting an inlet port to an outlet port, the housing including an inlet fitting about the inlet port for connection to the discharge outlet, in use;
a valve element rotationally supported in the interior chamber of the housing for movement between a valve open position and a valve closed position, the valve element comprising a spherical ball having a through bore defining a cylindrical interior passage, a wall extending across the interior passage separating an inlet side of the passage from an outlet side of the passage, the wall including a through opening, and an anti-backflow device received in the outlet side of the passage aligned with the through opening and moveable between a seated position and a spaced position relative to the wall, wherein flow from the inlet side to the outlet side moves the anti-backflow device to the spaced position to open the through opening and flow from the outlet side to the inlet side moves the anti-backflow device to the seated position to close the through opening; and
a handle for selective rotation of the valve element in the housing.

9. The bulk container anti-backflow ball valve of claim 8 wherein the anti-backflow device comprises a plate having a pair of stabilizing pins extending rearwardly from the plate, the wall comprises a pair of pin openings, and the stabilizing pins are received in the pin openings.

10. The bulk container anti-backflow ball valve of claim 9 further comprising backing screws on the inlet side of the passage threaded to the stabilizing pins to retain the stabilizing pins in the pin openings.

11. The bulk container anti-backflow ball valve of claim 10 wherein area of the through opening is substantially equal to planar area across the passage surrounding the anti-backflow device.

12. The bulk container anti-backflow ball valve of claim 8 further comprising a gasket between the anti-backflow device and the wall.

13. The bulk container anti-backflow ball valve of claim 8 wherein the anti-backflow device is maintained within the passage.

14. The bulk container anti-backflow ball valve of claim 8 wherein the housing comprises a plastic housing.
